(19) United States
(12) Patent Application Publication
(10) Pub. No.: US 2012/0208450 A1
(43) Pub. Date: Aug. 16, 2012

(54) LOCAL MEDIA DELIVERY DEVICE

(76) Inventors: David Sparks, Washington, IN (US); Todd Hammer, Washington, IN (US)

(21) Appl. No.: 13/372,836

(22) Filed: Feb. 14, 2012

Related U.S. Application Data
(60) Provisional application No. 61/442,578, filed on Feb. 14, 2011.

(51) Int. Cl. G06F 15/16; H04W 4/06

(52) U.S. Cl. 455/3.06; 709/217

(57) ABSTRACT

A media device is provided that allows for the distribution of media over a local area. A user opts in to receive the media and executes a connection to the media device. Various other features are also disclosed.

### PRIORITY

The present application claims priority to U.S. Provisional Application No. 61/442,578 filed Feb. 14, 2011 titled LOCAL MEDIA DELIVERY DEVICE, the disclosure of which is expressly incorporated herein by reference.

### FIELD

The present disclosure relates generally to media servers. More particularly, the present disclosure relates to media servers able to locally deliver rich media content.

### BACKGROUND AND SUMMARY

Mobile devices have become the preferred choice of communications among the population today or as they are more commonly called, Smartphones. Mobile devices such as cell phones, PDA's, laptops, notebooks and various types of tablets or notepads have become ubiquitous. Most users of such devices have one with them wherever they go. Mobile devices have been seamlessly integrated into our personal lives and have become a necessary part of our everyday activities. This is where traditional forms of advertising such as radio, television and printed media become less relevant to such users. As advancements in these devices increase there becomes a need for advertisers to use alternative forms from traditional methods for their content delivery. Additionally, there is a need to accurately measure advertising campaign effectiveness. Accordingly, there is a need for systems and methods for providing targeted wireless media content and information to mobile devices within a localized area relevant to the location of the user.

The disclosure pertains to the system and methods of providing targeted media content to wireless devices for advertising and for the distribution of other information to users of Wi-Fi or Bluetooth enabled devices. The system incorporates a localized server technology for Bluetooth and Wi-Fi delivery. The system further provides for the collection of statistical data for mobile users, but not limited to mobile users. The system allows for one or more advertisers to operate within the network to build, add to, or modify their campaign.

In one embodiment, a system is provided comprising a server, the server including memory and a server processor; and a distributed transceiver, including a wireless communication card, a transceiver processor, and a memory. The server memory storing instructions that when interpreted by the server processor cause the server to transfer a first media file to the distributed transducer. The distributed transducer memory storing instructions thereon that when interpreted by the transceiver processor cause the distributed transceiver to broadcast a wireless signal receivable by at least one wireless mobile device, allow the mobile device to wirelessly connect to the transceiver, and provide the first media file to the connected mobile device.

According to another embodiment, a media delivery device is provided comprising a housing; a memory within the housing and storing at least one media file; and a transceiver within the housing that emits a wireless signal receivable by one or more wireless mobile devices.

According to yet another embodiment, a computer readable media containing non-transitive instructions is provided. When the instructions are interpreted by a processor they cause the processor to: receive selections of a media campaign; identify at least one media file that is part of the selected media campaign; receive communication from a media delivery device suitable for distributing the media campaign; and transmit the at least one media file to the media delivery device.

### BRIEF DESCRIPTION OF THE DRAWINGS

The detailed description of the drawings particularly refers to the accompanying figures in which:

FIG. 1a is a perspective view of a media delivery device of the present disclosure;

FIG. 1b is a front plan view of the media delivery device of FIG. 1a;

FIG. 1c is rear plan view of the media delivery device of FIG. 1a;

FIG. 2 is perspective view of an embodiment where the media delivery device of FIG. 1 is housed in a kiosk;

FIG. 3 is a diagrammatic view of various entities and devices that interact with the media delivery device of FIG. 1;

FIG. 4 is a diagrammatic view of a administrative hierarchy employed to control the operation of the media delivery device of FIG. 1;

FIG. 5 is another diagrammatic view of interactions for usage and configuration of a content management server that interfaces with the media delivery device of FIG. 1;

FIG. 6 is an overhead view showing interaction of a user device with the media delivery device of FIG. 1;

FIG. 7a & b are perspective and plan views of a second embodiment media delivery device, similar to the media delivery device of FIG. 1;

FIG. 8 is a flowchart describing the interaction between a user device and the media delivery device of FIG. 1; and

FIG. 9 is a diagrammatic view of the delivery device of FIGS. 1 and 7.

### DETAILED DESCRIPTION OF THE DRAWINGS

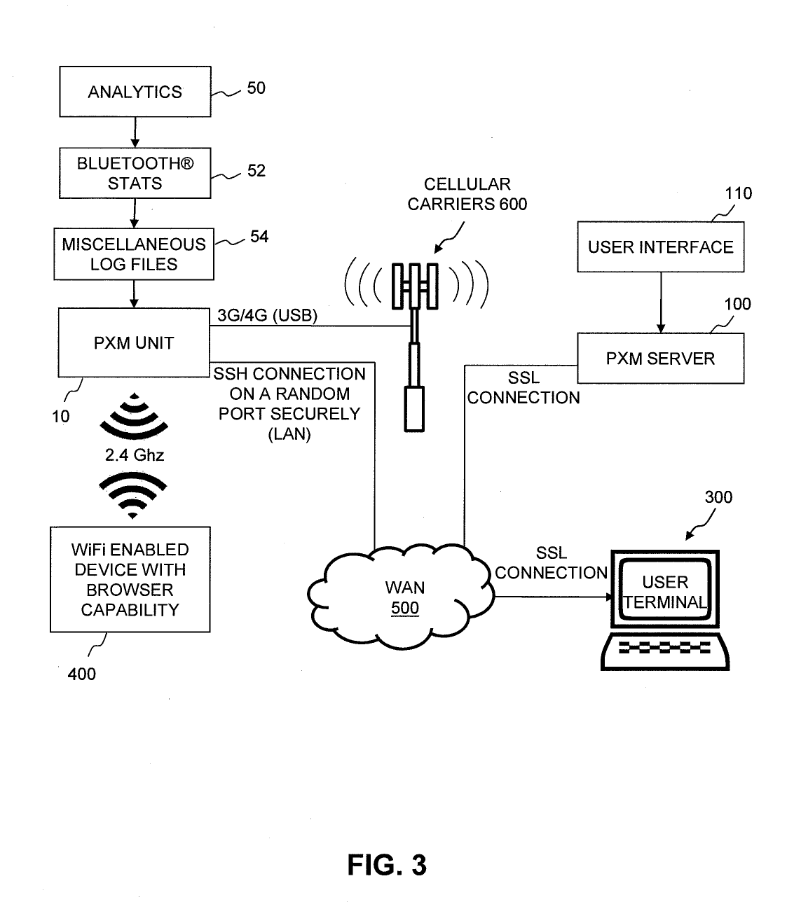

FIG. 3 shows system having a plurality of devices that are able to communicate, either directly or over a network. The system includes content management server 100, content delivery device 10, analytics terminal 300, and one or more mobile devices 400.

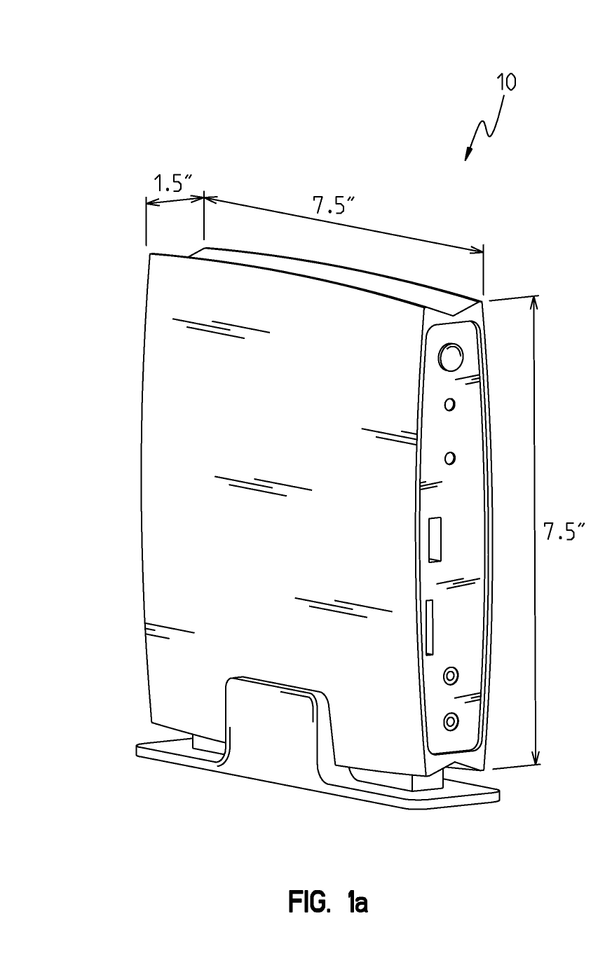

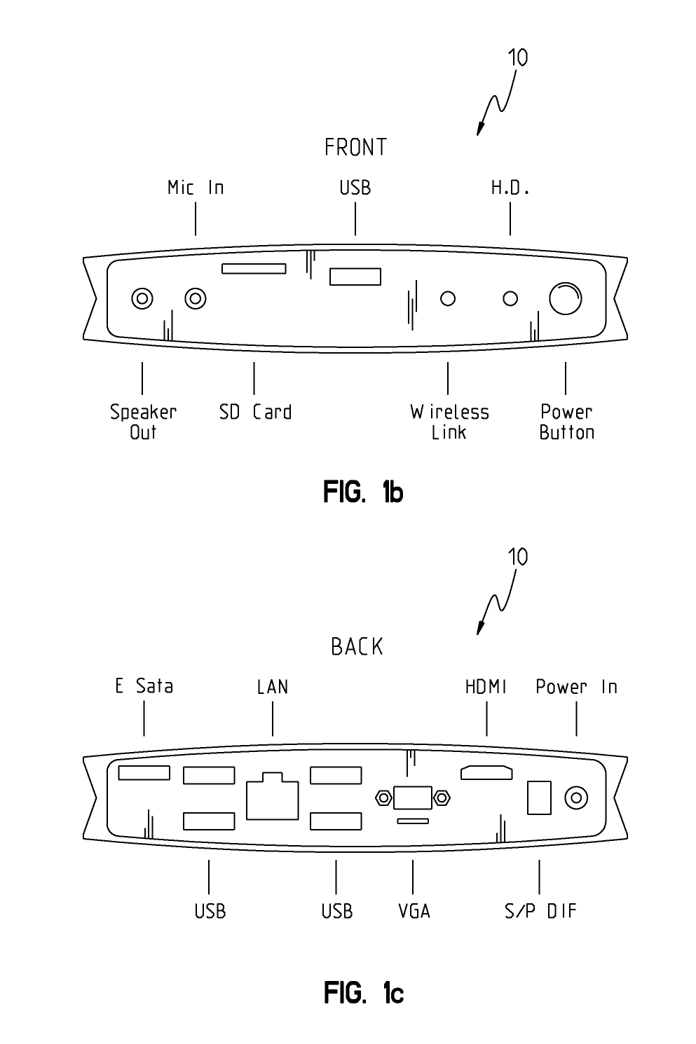

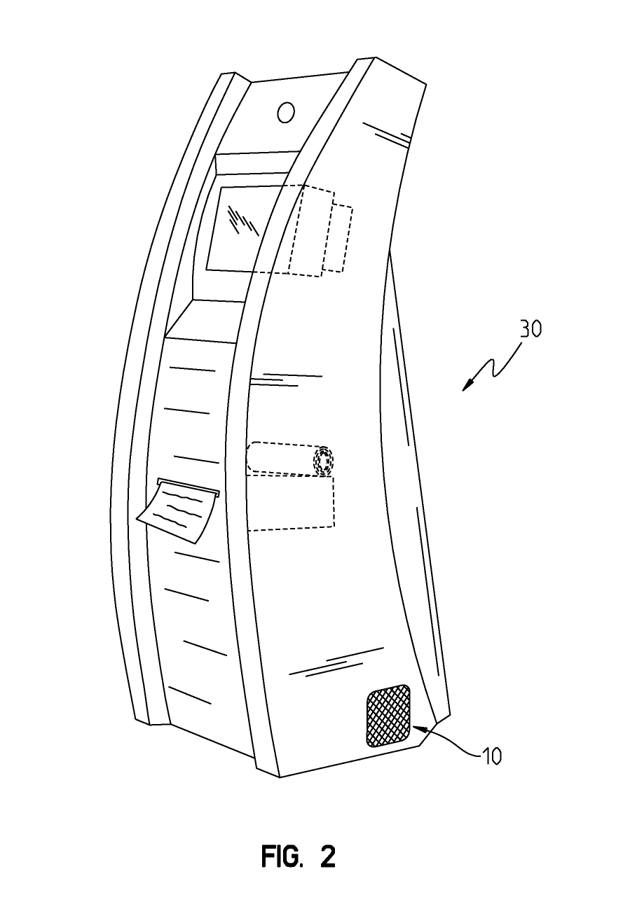

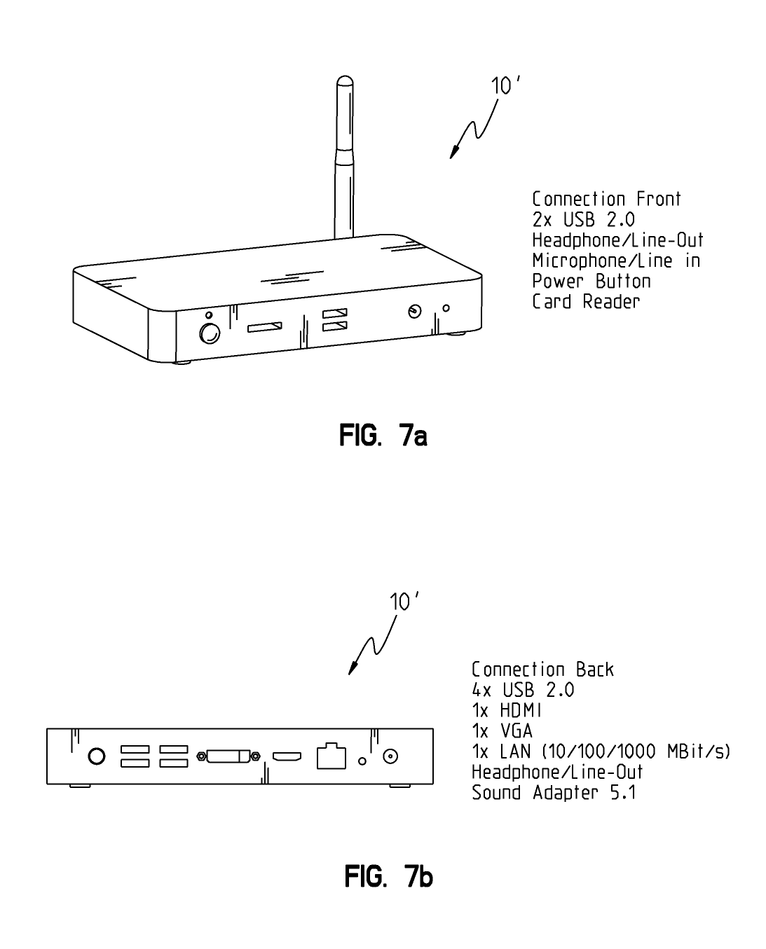

FIGS. 1a-c show media delivery device 10 having a plurality of ports. FIGS. 1a-c also list various internal components of the device 10. Device 10 can be put to a number of uses and contains software to allow it to achieve these uses. FIGS. 7a&b show an alternative embodiment device 10′ able to operate substantially similarly to device 10. Device 10 is illustratively a PXM (processor switch module) unit. In one embodiment, the PXM uses an ICR NT535 SFF Barebone Chassis Unit with integrated motherboard 12 from Systemax. An exemplary device 10, 10′ further includes: 049019 Free DOS operating system, an Intel D525 Dual core 1.8 GHz processor 14; 2 GB PC5300 DDR2 667 MHz SODIMM (2 GB x 1) Memory 16; an integrated power supply, a SD/SDHC/MS/MS Pro/MMC 5 in 1 Card Reader 18; Intel®Graphics Media Accelerator 3150 (20); Integrated Gigabit LAN 22; NAO ATHEROS MC B/G/N IEEE 802.11 (24); and OCZ SLD3-25SAT3-120G Solid 3 Series Solid State Drive-120 GB, 2.5″, SATA III, 6 Gbps 26.

FIGS. 1a-c and 7a&b depict device 10, 10; displaying multiple ports of media interface card 18 for various types of connections which can be used for additional functions such as additional storage, audio out, video out and remote external antenna connection. Such ports include but are not limited to eSata, USB, LAN, VGA, HDMI, S/PDif, and power. Device 10, 10′ has its own internal hard drive 26 complete with a server and database. Device 10, 10′ also has transceiver hardware 24 suitable for providing Wi-Fi and Bluetooth wireless signals. By having the transceiver hardware therein, device 10, 10′ is also considered a transceiver. The server on device 10, 10′ runs a “cron” (a time-based job scheduler that enables users to schedule jobs) every 60 seconds. The primary function of the cron is to “call” back to Content Management Server (CMS) 100. Device 10, 10′ then looks to CMS 100 for software or firmware updates, instructions to changes its parameters and new campaigns. In one embodiment, device 10, 10′ is unable to request any specific files from CMS 100. Device 10, 10′ simply asks if there any files that CMS 100 wishes to send. CMS 100 dictates which files are sent.

Content management server 100 is illustratively a standard PC with content management software thereon. The content management software allows server 100 to build campaigns, manage campaigns, manage users, manage devices or groups of devices, and manage organizations. Server 100 also transmits the data via secured connections between analytics terminals 300 and content delivery devices 10. Details regarding the operation of content management servers 100 are provided below.

Analytics terminals 300 allow users to access content management servers 100 and content delivery devices 10. Analytics terminals allow viewing, downloading, storing, and manipulation of analytics data (50, 52, 54) collected and/or stored on content management servers 100 and content delivery devices 10. Analytics terminals 300 can also function as user interfaces 110 for content management servers 100.

Content management server 100 hosts a database repository of software that is used to manage back-end functions. Content management server 100 utilizes a secure connection to user analytics terminal 300. Once an organization(s), campaign(s) and user(s) have been configured then the information can be transmitted via the internet (wired, wireless, or a combination) to content delivery device 10. Content delivery device 10 collects and stores the analytics, statistics and logs (50, 52, 54) as well as archived campaigns that can be transmitted to content management server 100 to be viewed by user terminal 300 and/or user interface 110, these terminals/user interfaces can be any device with internet connectivity. The connection for this process is done via an encrypted tunnel connection on a randomly generated port to create a secure LAN connection. Campaigns running on a content delivery devices 10 are transmitted via Bluetooth or Wi-Fi broadcasts that are not encrypted and free to air for any device 400 capable of reception

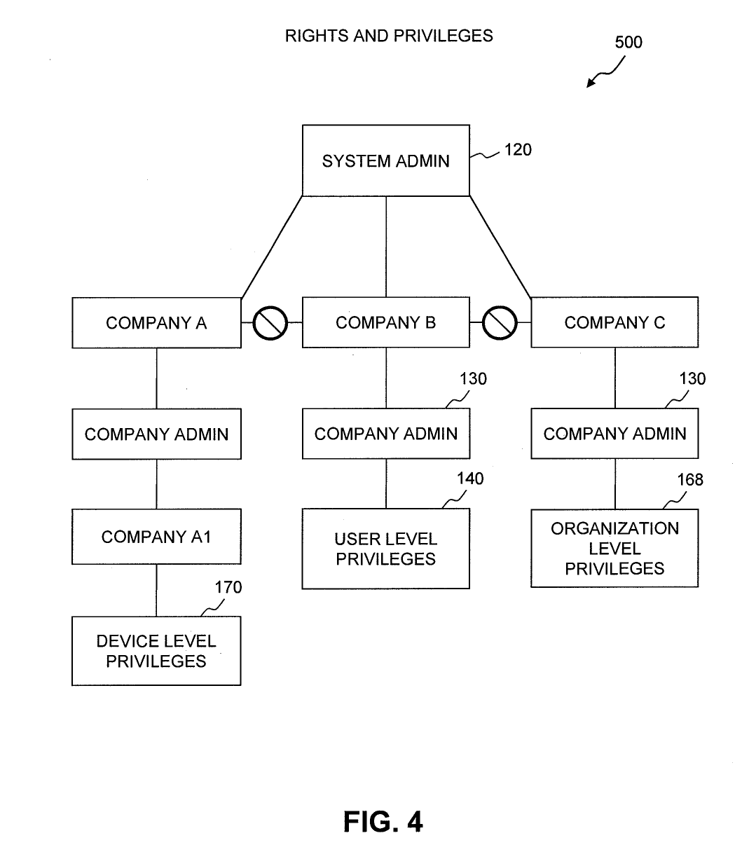

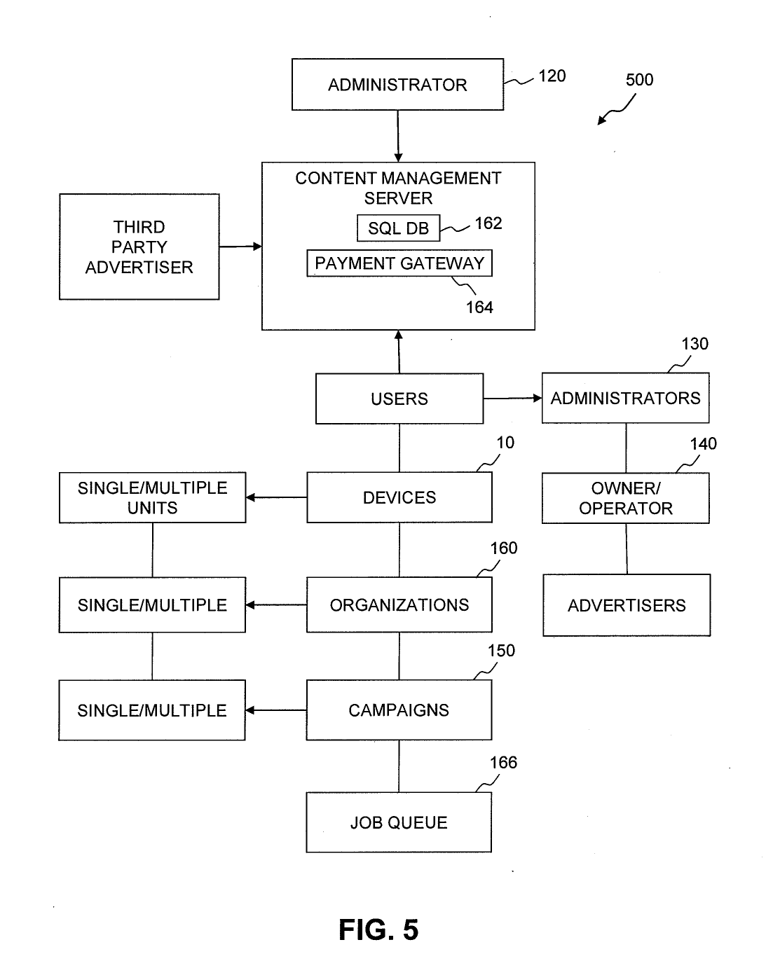

FIGS. 4&5 show an embodiment of customer relationship management (CRM) software 500 architecture suitable for use on content management server 100. Software 500 embodies a system and platform that when interpreted by a processor, provides for management of devices, organizations, campaigns and transmission of media content consisting of, but not limited to .jpg, .gif, .mp4, .mp3, .mov, .pdf, Microsoft Office files, and html files. The illustrations of FIGS. 4&5 are typical but not limited to the connections between the content management server 100, administrators, owner/operators and advertisers as they communicate to deployed content delivery devices. To access server 100, a user will need to access the web domain associated with the server 100. The process is as follows:

Once the user has successfully connected to server 100 via the website they will select the login button on the website. When the button is selected they will then be redirected to a secure website where they enter login credentials that are provided to them from an administrator 120 (company administrators 130 receive credentials from system administrator 120, whereas company users 140 may receive credentials from company administrators 130). Additionally, while access is discussed as being tied to a user, it should also be appreciated that access can be tied to organization 168 or device 170 levels. Upon validation of the credentials the user will have access to their own user interface to the content management server 100. Here company administrators 130 have control over their own account and have the ability to manage their own campaigns, manage multiple organizations 160, and depending on their privileges can create other users 140, campaigns 150, and manage devices 10. The CRM consists of database 162, payment gateway 164, support files, management programs and job queue 166. To load a campaign/web page you can simply build any web design, then ZIP it into a .zip format.

The user then adds the file to the set of available campaigns. Once the file is added to the available campaigns, it can be selected at the management website hosted on content management server 100. Selection of the campaign at the website allows the user to specify devices 10, 10′ on which to employ the campaign and to customize the times that the campaign is active.

The selected campaign is then staged in job queue 166. There the campaign will wait until the specified time and date to be sent via a secure port over the internet to one or more devices 10, 10′. Once sent to device 10, 10′ the campaign previously being run on that device 10, 10′ is then archived and labeled by a time and date stamp. It should be appreciated that campaigns for multiple companies can be run on a single device 10, 10′. Accordingly, the above discussion regarding the archiving of a previously run campaign refers to a campaign previously run on behalf of the company implementing the new campaign.

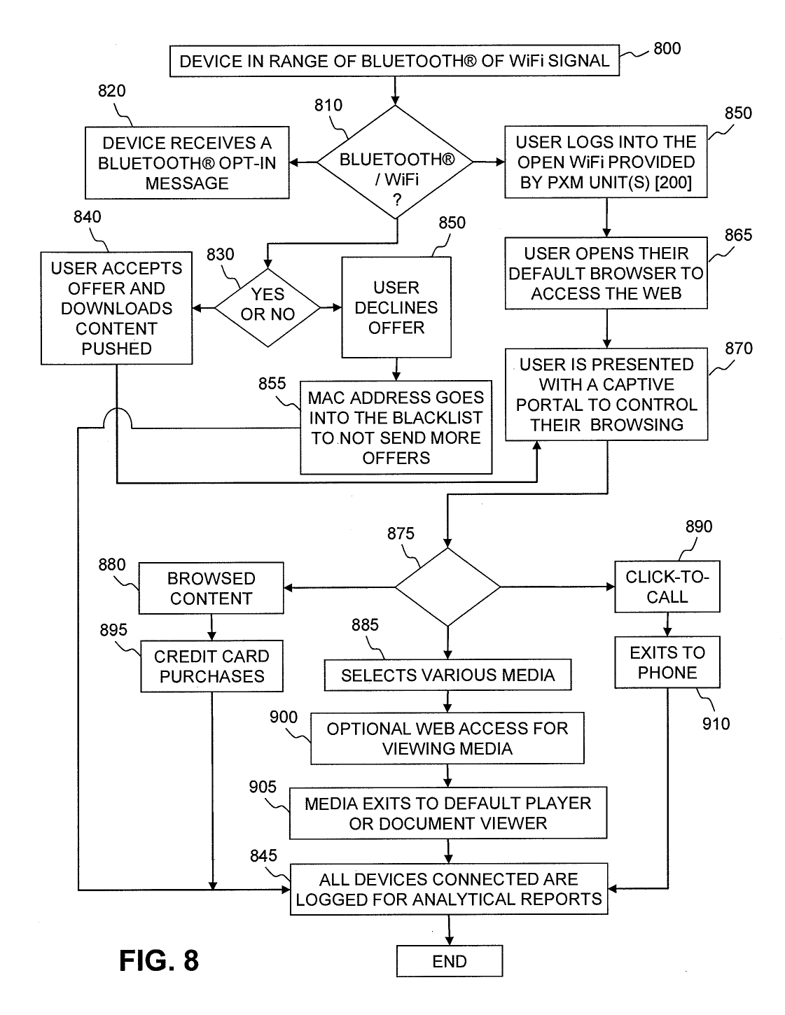

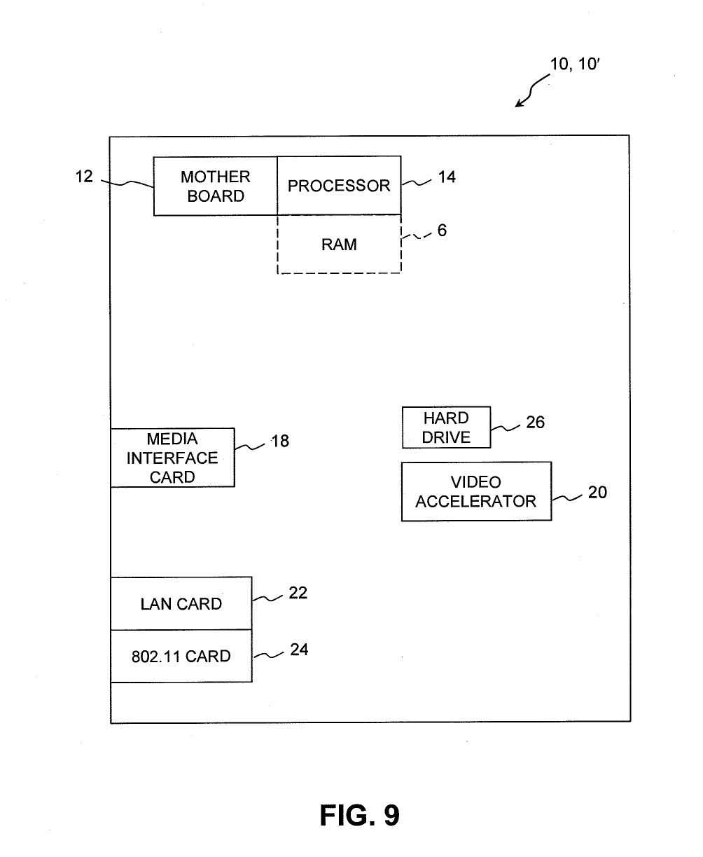

According to one embodiment, with reference to FIG. 8, device 10, 10′ is used as follows:

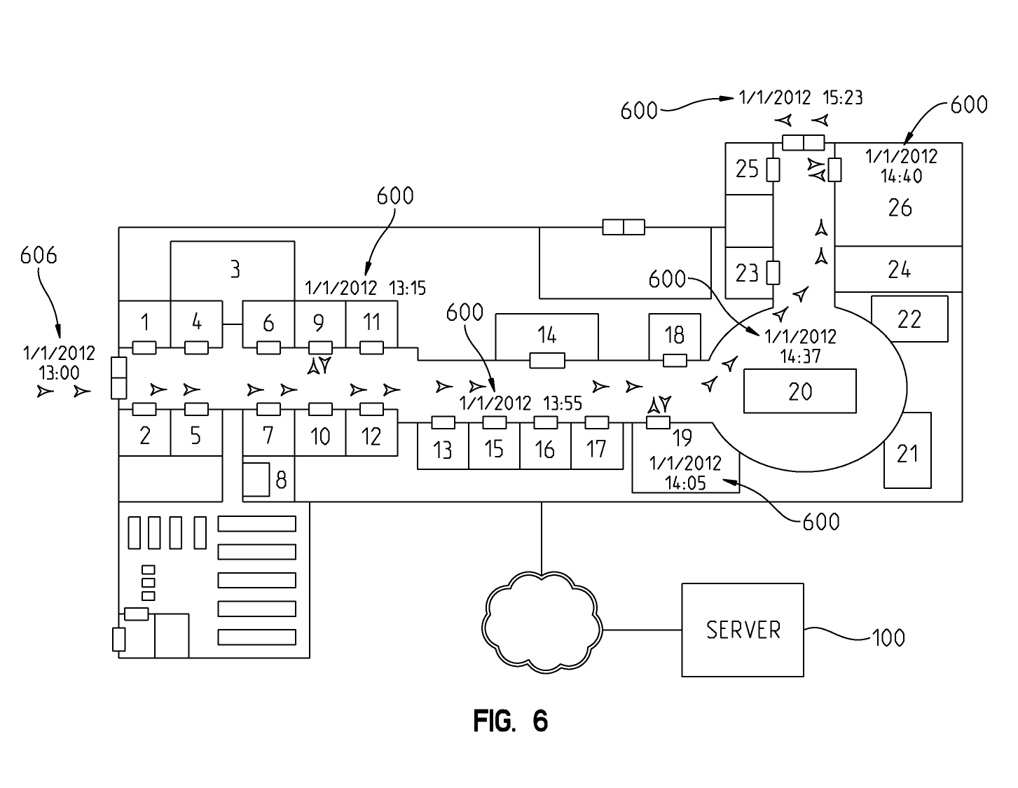

A Bluetooth and/or Wi-Fi broadcast from device 10 is sent out to all enabled Bluetooth/Wi-Fi devices 400 within 300′ (or other desired radius). When a device 400 is within range, device 400 receives one or both of the Bluetooth/Wi-Fi signals. (Box 800) The device 400 selects one of Bluetooth and Wi-Fi to connect, or if only one connection protocol is active or received, there is no choosing, only an acceptance of a connection. (Box 810) If Bluetooth is selected, traditional Bluetooth handshaking is performed between device 400 and device 10. Such handshaking includes an OBEX push of content via an opt-in process to Bluetooth enabled devices that are in discoverable mode. Once connected, device 400 receives an opt-in offer. (Box 820) The user of device 400 then chooses whether to opt-in. (Box 830) If the opt-in offer is accepted an image, audio, or video file(s) is sent to enabled device 400 with instructions. (Box 840) Device 400 logs the date and time that device 10 connected, logs the MAC address (or any other device-unique identifier) of device 10, and logs information regarding which content was accessed by device 10. (Box 845) Still further, in one embodiment, the data logging includes time and date stamps 600 associated with MAC addresses or other unique identifiers linking mobile devices 400 and/or users to specific locations within the area covered by devices 10, 10′ to establish a timeline or pattern of paths traveled. (See, FIG. 6)

Once a particular mobile device 400 is detected, via Bluetooth and MAC addresses or otherwise, device 10, 10′ and “remembered”. Device 10, 10′ then watches for other indications that mobile device 400 is connecting and may or may not send further offers to device 400. In some embodiments, device 10, 10′ shares it's list of discovered MAC addresses with neighboring content delivery devices 10, 10′ in the area so that they will become aware that device 400 is a “known” device on the network.

If the opt-in offer is rejected, (Box 850) device 400 becomes blacklisted for that particular campaign. (Box 855). Again, device 400 logs the date and time that device 10 connected, logs the MAC address (or any other device-unique identifier) of device 10, and logs an indication that no content was accepted. (Box 845)

As part of Box 840, exemplary opt-in instructions provided to a user via device 400 are as follows:

1) Turn on your Wi-Fi in your Wi-Fi enabled device

2) Look for and connect to the network of device 10

3) Open your web browser

Once the web browser is opened, the process is moved to Box 870, discussed further below.

If, back at Box 810, the user of device 400 selects to connect via Wi-Fi, the user logs into the open Wi-Fi provided by device 10. (Box 860) Once connected, the user opens the onboard web browser on their device 400. (Box 865)

Once connected to device 10, 10′, network device 400 is allocated an IP address from a pool of available addresses by a DHCP server on device 10, 10′. Included in the allocation for device 400 is a DNS server IP address, which points back to device 10, 10′. Device 10, 10′ is configured to resolve all DNS requests to the IP address of device 10, 10′. The cache time of the DNS requests resolved by device 10, 10′ is deliberately short (60 seconds) to ensure that device 400 operates normally once connected to the public network. Subsequent web requests made by device 400 are, having been resolved by DNS to point to device 10, 10′, is handled by the web server on device 10, 10′ and re-directed and re-written with the domain name that is currently in operation on device 10, 10′. This method provides a “captive portal” experience to device 400 in that every web page request made by device 400 will result in content provided by device 10, 10′ for handling. (Box 870)

When the device 10, 10′ web page opens full media content can be delivered to the mobile devices. Web pages will consist of a single client or multiple clients with a mobile web menu and contain the ability to sort through the client list by category, product or client name. It should be noted that embodiments are envisioned where the entire browsing experience while connected to device 10, 10′ is controlled and only content residing on device 10, 10′ can be viewed unless otherwise specified. This is accomplished due to device 10, 10′ having its own internal hard drive complete with a server and database.

Additionally, the user can be presented with a choice (Box 875) of any number of opportunities including browsing provided content (Box 880), selection of media to consume (Box 885), and to make a phone call to the content provider or otherwise (Box 890). It should be appreciated that a user may perform any number of the events described in Boxes 880, 885, 890.

Examples of provided content (Box 880) include being given the opportunity to save a file in the form of an image to be presented later as a discount. Alternatively, a user can be given instructions on how to redeem a discount. Additionally, a user may be presented with purchasing options that can be completed via entering of credit card information (Box 895). The access and other analytical data is then stored for reporting (Box 845) as described in more detail below.

While the web access presented by device 400 is described as limited, a user may be presented with the ability to gain non-limited access to the web. In one embodiment, to gain this access the user is required to view a media video. (Box 900) If the user selects media in the form of an audio or video stream or a download the default media player or document viewer may open to view the content. (Box 905) After viewing the content, the user is provided non-limited web access. The access and other analytical data is then stored for reporting (Box 845).

If the landing page, or any subsequent page, presented via the browser is configured with a telephone number it will provide the ability to click-to-call (Box 890). Click-to-call is a phone number that as recognized by browsers as an external link in the form of a valid telephone number. If the number is clicked the browser exits and the appropriate dialer program is called and the call is placed (Box 910). In the event that the connected device lacks a dialer, an error message is received that the device does not recognize the command to dial.

In addition to the collecting of data regarding users and user devices 400 that access device 10, analytical data includes data received from using Bluetooth as a method of counting and tracking Bluetooth enabled devices 400 by passively scanning for unique Bluetooth MAC addresses. Similar to the treatment of devices 400 that connect via Bluetooth, all devices 400 that connect to device 10, 10′ via the Wi-Fi connection are logged by their unique MAC address and browser. Analytics are then generated from the page views, entry and exit pages, time spent interacting with device 10, 10′, time per page, outlinks, downloads, returning visits, and other statistical data. Device 10, 10′ also detects the type of phone (or tablet or computer, i.e. Android, Iphone, Symbian etc.) Device 10, 10′ detects the type of web browser being used per mobile device. Device 10, 10′ then uses the detected data to send the appropriate video format per phone and browser detection that is to be viewed. The software allows for multiple connections that can be viewed, paused or stopped by each user independently of other users that may be watching the same video. As previously noted, the software stores data about each connection including time, date, files viewed, and MAC addresses. This is exemplary of the data stored at box 845.

In models where device 10 is in service as a kiosk 30 (FIG. 2) with a touch screen display, kiosk 30 has the capability to print discounts with a thermal printer.

As a person approaches Kiosk 30 they will be able to view a 42 inch screen with device 10, 10′ at the core of the unit. The screen will display an infomercial about discounts that are relevant to the kiosks current location and nearby clients. The screen will also display the call-to-action message to inform people as they pass by that they can access the Wi-Fi network. The display will give explicit instruction on how to so. Both the infomercial and the call-to-action will loop continuously until the touch screen is activated. The looped videos will display the “touch me” message to prompt a user to interact with kiosk 30. Once activated kiosk 30 will pull up a web browser type application where you can scroll through all offers that are available. Offers will be found via searching a particular store, category or item. Once the offer is found it can then be printed out on an onboard thermal printer.

A second embodiment, device 10 operates similarly to the first embodiment. The second embodiment operates to deliver streaming HD video content. The first embodiment can offer this as well but is mentioned here specifically. The HD media is streamed, not downloaded or stored. It can be offered as a free service from making a prior purchase and activated via a code. The media content can also be purchased at any time via a 3^{rd} party client to manage the transaction. Device 10, 10′ will store approximately ten 720p HD movies and web pages. Clearly, advances in memory technology will allow increased storage for less expense.

A third embodiment, device 10 operates similarly to the second embodiment, with the addition of overlay functionality. The third embodiment device 10 includes enhanced software features using HTML 5 to apply a transparent overlay over the existing video stream.

At any point of the HD video stream an ear mark for product placement can be placed. This will be represented as a pop up on the video screen in the form of a flashing stop sign on the lower right hand side of the screen. The user then has the option to ignore this symbol or pause and click on the symbol. Once the user activates the symbol, another window will pop up in full screen mode. It allows the user to have additional information about the product placement items or the ability to purchase the product. Once the transaction is complete and the pop menu screen is closed, the HD Stream will resume from the point at which it was paused.

The above embodiments are envisioned for use in a wide variety of settings. Some of these uses/settings are listed below.

Hospitalities: Restaurants, Hotels & Motels, Bed & Breakfast and others business can deliver specials, service concepts, and address of branches, E-coupons or Menus. And offer games and entertainment while you wait.

Small Retail: Small retailers have the ability to the level the playing field with their larger counterparts. Regardless of what your specialty is, more customers' means more sales by using our low cost solution for advertising which operates 24/7.

Real Estate Property: New home Sales catalog and interior plans downloads. Use to promote individual listings and deliver calendar events for up-coming Open House inspections. Deliver buying information around the clock.

Transportation, Tourism and Ticketing: Airports, stations, terminals and other hot-spots could place devices 10 that can show and send the local tourism and accommodation information, distribute e-coupons and stream entertainment media such as music or movies.

Banking: Banks and Financial Institutions, promote your latest offers, rates etc. We could also send the address of every branch and other important information. It can be networked over your service area.

Large Retail: Shopping malls, commercial buildings, department stores, supermarkets, wholesale markets and chain stores. Undertake a Nationwide coordinated product launch or special discount offer with ease. Device 10 can be linked via a cluster to provide and instant network update nationwide.

Automotive and Recreation Vehicles: New and Used Vehicle dealers can display their inventory list and sales contact information. Make buying information available after hours.

Service and Trades: Whether you are a plumber, builder, roofing contractor, electrician, pool repair, carpet layer, or a lawn care & landscaper. Take device 10 with you and you'll be promoting your business in the locations where you do the most work.

Marketing is always a challenge to develop product or brand recognition. Many companies use what we refer to as saturation marketing, basically saturating every possible media with ads for the product or brand. It is more of a shotgun approach, expensive and typically not target specific. In the current economic climate these types of strategies are becoming less attractive. Device 10 provides a very cost effective method of marketing to mobile users. Because there are no costs to send or receive advertisements, it could be the best alternative to reach mobile users to date.

While device 10, 10′ has been described as being connected to the internet, it should be appreciated that embodiments are envisioned where for a user connecting their mobile device 400 to device 10, 10′ the experience and presented data are wholly contained on device 10, 10′ without triggering or requiring that device 10, 10′ make an external call to satisfy browsing requests of device 400.

Although the disclosure has been described in detail with reference to certain preferred embodiments, variations and modifications exist within the spirit and scope of the disclosure as described and defined in the following claims.

1. A system comprising:
a server, the server including memory and a server processor; and
a distributed transceiver, including a wireless communication card, a transceiver processor, and a memory;
the server memory storing instructions that when interpreted by the server processor cause the server to:
transfer a first media file to the distributed transducer;
the distributed transducer memory storing instructions thereon that when interpreted by the transceiver processor cause the distributed transceiver to:
broadcast a wireless signal receivable by at least one wireless mobile device,
allow the mobile device to wirelessly connect to the transceiver, and
provide the first media file to the connected mobile device.

2. The system of claim 1, wherein the server transfers the first media file by:
queuing the media file, and
responding to communication initiated by the transducer by sending the media file.

3. The system of claim 1, wherein files available to be provided to the connected mobile device are restricted to those files that are stored in the memory of distributed transceiver.

4. The system of claim 1, wherein the instructions stored on the transceiver memory further require that all IP connection requests received from mobile devices wirelessly connected to the transceiver be resolved to direct to the transceiver itself.

5. The system of claim 1, wherein the instructions stored on the transceiver memory further require that the transceiver attempt to connect to the server periodically.

6. The system of claim 1, wherein the instructions stored on the server memory cause the server to create a queue of at least one media file such that receiving a connection from the transceiver causes the queued at least one media file to be transferred to the transceiver.

7. The system of claim 6, further including a second distributed transceiver and wherein the queue is provided such that receiving connections from each of the transceivers causes the at least one media file to be sent to each of the transceivers.

8. The system of claim 1, wherein the transceiver is unable to request a specific file from the server.

9. The system of claim 1, wherein the instructions stored on the transceiver memory, when interpreted by a processor further provide the mobile device with the opportunity to opt-out of communications from the system.

10. The system of claim 9, wherein receiving an indication that a mobile device has sent an indication of opting out results in such opting out being reported to the server.

11. The system of claim 10, wherein the instructions stored on the server memory respond to the indication of opting out by placing information identifying the mobile device into the queue such that any other transceivers are able to be informed of to the opting out information.

12. A media delivery device comprising:
a housing;
a memory within the housing and storing at least one media file; and
a transceiver within the housing that emits a wireless signal receivable by one or more wireless mobile devices.

13. The media delivery device of claim 9, wherein granted requests to connect to the media delivery device are cause the media delivery device to accept the request and allow access to files stored in the memory of the media delivery device without allowing access to files not stored on the memory of the media delivery device.

14. The media delivery device of claim 9, the memory is a hard drive.

15. The media delivery device of claim 12, wherein the memory stores a first media file and a second media file, the first media file being part of a first campaign for a first entity, the second media file being part of a second campaign for a second entity.

16. The media delivery device of claim 15, wherein the first entity is able to make changes to the first media file and is unable to make changes to the second media file.

17. A computer readable media containing non-transitive instructions, that when interpreted by a processor cause the processor to:
receive selections of a media campaign;
identify at least one media file that is part of the selected media campaign;
receive communication from a media delivery device suitable for distributing the media campaign; and
transmit the at least one media file to the media delivery device.

18. The computer readable media of claim 17, wherein the media delivery device did not specifically request the at least one media file.

19. The computer readable media of claim 17, wherein the instructions further cause the processor to receive indications of media delivery devices on which the selected media campaign is desired to be implemented.

20. The computer readable media of claim 19, wherein the at least one media file is distributed to all indicated media delivery devices.
